(19) United States
(12) Patent Application Publication
(10) Pub. No.: US 2024/0326509 A1
(43) Pub. Date: Oct. 3, 2024

(54) IDENTIFICATION DOCUMENT, SYSTEM ARRANGEMENT AND METHOD FOR PRODUCING AN IDENTIFICATION DOCUMENT

(71) Applicant: GIESECKE+DEVRIENT EPAYMENTS GMBH, Munchen (DE)

(72) Inventors: Klaus KOHL, Miesbach (DE); Gunter ENDRES, Passau (DE); Cristina FABIAN, Garching (DE)

(21) Appl. No.: 18/578,953

(22) PCT Filed: Jul. 6, 2022
(86) PCT No.: PCT/EP2022/025313

§ 371 Date: Jan. 12, 2024

(30) Foreign Application Priority Data
Jul. 13, 2021 (DE) 10 2021 003 599.2

(51) Int. Cl. B42D 25/435; B42D 25/455

(52) U.S. Cl. CPC B42D 25/435; B42D 25/455

(57) ABSTRACT

An identification document includes a carrier element, which has a surface with a personalization region. A first personalization layer is integrated in the carrier element in the personalization region at a depth below the surface; and a second personalization layer is located on and/or in the surface in the personalization region. A laser additive is integrated in the second personalization layer and/or in a protective layer arranged above the second personalization layer. The first personalization layer is a laser engraving formed by carbonizing the material of the carrier element. The laser additive contains particles, which absorb energy from a laser. A sensitization to laser beams can be weaker in the carrier element than in the second personalization layer and/or the protective layer. The first personalization layer may contain a black portion and the second personalization layer may contain a colored portion of a color image.

The invention relates to an identification document and to a system arrangement and to a method for protecting a personalized identification document against subsequent tampering.

Identification documents are an important part of modern societies in that they make it possible to identify individuals and/or disclose certain rights held by their holders. For example, an identification document may be a card or a data carrier and be in the form of a passport, a personal ID card, a driver's license, a bank card, such as a credit card or cash card, a label and/or an access card. Owing to their great importance for everyday life, for example for commercial interactions and access restrictions, it is particularly important to protect identification documents against forgery. To this end, identification documents may have one or more security features which make it possible to verify the authenticity of the identification document and make it more difficult to forge and/or manipulate identification documents.

To link the identity of an institution or individual, an identification document may be personalized, for example with an image applied to the surface or embedded or introduced in the depth of the identification document.

EP 0 537 484 A1 discloses an identification document in the form of a data carrier for colored or bright pictorial information. The identification document consists of a card insert which acts as a light-scattering background and a transparent film arranged thereon, on which a color-accepting layer is arranged. The transparent film serves as a substrate, into which optically identifiable information for personalization purposes can be inscribed by blackening the film material using laser radiation. The color-accepting layer can be printed with color by applying or introducing dyes or pigments for personalization purposes. When dyes are mentioned below, this always also means pigments. To record a colored image onto the identification document, firstly the pictorial information of an image to be recorded is broken down into a light/dark portion and at least one color separation as colored portion. The light/dark portion is inscribed into the transparent film by means of a laser writer, as a result of which more or fewer blackened regions of a grayscale image are produced. Then, the one or more color separations of the pictorial information are superposed on the grayscale image as a colored image by applying or introducing corresponding dyes onto or into the color-accepting layer.

What happens is that an identification document is not forged as a whole, but rather that a real identification document that is present is forged in such a way that only individual items of data on the identification document, such as an image introduced onto the document, for example of the holder, are manipulated. A form of tampering referred to as the face morphing attack, which aims to present a face reference image that can be successfully matched to more than one individual automatically and by human experts, is known. Such an attack can constitute a decisive security breach if an identification document comprises an image manipulated by morphing. An identification document forged (“morphed”) in this way can allow more than just one individual to verify their identity using that linked to the identification document. A false linkage of subjects to the document identity that is created in this way can enable a multiplicity of illegal activities, such as financial transactions, illegal immigration, human trafficking and the circumvention of legal identity blacklists.

It is conceivable that the face morphing attack above is carried out on an identity document which has already been linked to the document identity, i.e. personalized, by way of a photo of the document holder. For the face morphing attack, it would be possible to selectively add pictorial information to the photo that is present such that the identification document presents a face reference image that can be successfully matched to a further individual automatically and by human experts. For example, in the case of the identification document known from EP 0 537 484 A1, it would be possible to inscribe additional light/dark information into the transparent film by means of a laser writer, in order to manipulate the grayscale image according to the principles of the face morphing attack. It would correspondingly be possible to add color information to the color image that is present on the identification document and superposed on the grayscale image by adding corresponding dyes onto or into the color-accepting layer, with the result that the colored pictorial information is likewise manipulated according to the principles of a face morphing attack.

An object of the present invention is to provide a more tamperproof identification document and a method for protecting a personalized identification document against subsequent manipulation, in particular a face morphing attack. In particular, by improving the tamperproofing with respect to already known identification documents, it is possible to overcome advances that are made in the manipulation of identification documents. In particular, the provision of protection for an identification document against forgery or manipulation of pictorial data of the identification document that are personalized by means of a laser and/or for example inkjet printing technology, for example by subsequent, predominantly partial overprinting and/or subsequent partial laser personalization, is desirable, for example for the aforementioned face morphing attack; in other words, it would be advantageous for the identification document if the personalized pictorial data of the identification document could be protected against subsequent forgery (for example by morphing), or such an attack could at least be made more difficult.

These objects are achieved by the subjects of the independent patent claims. The respective dependent claims contain advantageous embodiments and expedient refinements of the invention.

According to a first aspect, an identification document according to the invention comprises a carrier element with a surface which has a personalization region. A first personalization layer is integrated or embedded in the carrier element in the personalization region at a depth below the surface. A second personalization layer is located on and/or in the surface in the personalization region. As a further concept, it is provided that a laser-sensitive additive (laser additive) is present in the second personalization layer or in a protective layer arranged above the second personalization layer.

It should be noted that, if the laser additive is integrated in the second personalization layer, the protective layer can be omitted, or alternatively still be present, wherein in that case the protective layer may, but does not need to, contain the laser additive.

“At a depth below the surface” can mean in principle that the first personalization layer is located directly below the surface and thus below the second personalization layer, wherein the depth is then substantially zero. “At a depth below the surface” preferably means that the first personalization layer is integrated or embedded in the interior of the carrier element at a spacing from the surface and thus at a spacing from the second personalization layer.

“On the surface” means that the second personalization layer can in principle be arranged on the surface, with the result that the surface is virtually the boundary layer between the carrier element and the second personalization layer. “In the surface” means that the material and/or the surface of the carrier element and/or the material of the second personalization layer may be formed such that constituents of the second personalization layer can penetrate into the depth of the carrier element from the surface or the second personalization layer can extend into the carrier element from the surface over an area, for example owing to a structuring of the surface. Of course, it is likewise possible that the second personalization layer is formed such that it is both on and in the surface.

Preferably, the first personalization layer can present a neutral color portion or black portion and the second personalization layer can present a colored portion of an image or a logo. The first personalization layer and the second personalization layer may particularly preferably be aligned overlapping one another in register in the direction of a normal to the surface of the carrier element. This has the advantage that, when the carrier element is viewed from above, i.e. in the direction normal to the surface, by a human observer, the personalization layers together form a color image with particularly pronounced black portions, because the black portion is added as a real grayscale image or black image of the first personalization layer.

In a particularly preferred embodiment, the first personalization layer and the second personalization layer together present a colored image or photo of the face of the holder of the identification document to whom the document identity is linked.

The first personalization layer is preferably a laser engraving embedded or integrated in the carrier element. “Laser engraving” is to be understood here as meaning “marking by means of a laser”, i.e. material does not need to be removed. Rather, the first personalization layer can preferably be formed by carbonizing the material of the carrier element at least in certain regions.

In particular, it is provided that the first personalization layer presents the black portion of an image or a logo and is formed by an integrated laser engraving in the material of the carrier element. In this case, the black portion is integrated in the interior of the carrier element in particular in such a way that the surface of the carrier element is mechanically unimpaired.

The laser engraving integrated in the carrier element in this way can be created in particular in that, during the manufacture of the carrier element, a laser additive, for example particles designed to absorb energy from a laser beam, are introduced into a material of the carrier element at least at the location or in the region of the first personalization layer. The laser additive may be in the form of carbon black particles and/or metal oxide nanoparticles, for example.

The integrated laser engraving is preferably introduced into the carrier element by a laser. In particular, the integrated engraving may be an engraving according to what is referred to as the LPI principle (Laser Protected Image). An LPI engraving is particularly precise and very durable in the long term. This is advantageous because the LPI engraving can be used to make at least the outline or the black portions of a color image more stable in the long term, since in this way the black portion of the personalization information is displaced into the interior of the carrier element and thus better protected against environmental influences.

The material of the carrier element is preferably at least light, for example white, or transparent in the region of the first personalization layer and in the non-engraved, i.e. non-personalized, state. Similarly, the material of the carrier element is transparent at least to visible light in the region between the first personalization layer and the second personalization layer.

To personalize the identification document, the laser-sensitive particles of the laser additive that are integrated, in particular dispersed, in the material of the carrier element can be heated by a laser. The particles of the laser additive discharge at least some of the heat energy absorbed in the process to the surrounding material of the carrier element. The material of the carrier element at least in this region is preferably selected such that its color changes, therefore becomes darker, in particular black, as a result of the heating, in order to thus be able to present the black portion of the image or logo. In particular, the material of the carrier element carbonizes in the region of the heating during the integrated laser engraving operation and consequently assumes a darker, in particular black, color there. The first personalization layer in the form of the integrated engraved black portion is advantageous because it is particularly resistant to aging, weather and wear as a result. The integrated engraving makes it possible to make the black portion particularly precise and resistant. An integrated engraving of the carrier element is difficult to produce with sufficient quality, that is to say a quality that cannot be identified as inauthentic, in particular for manual forgery.

The second personalization layer is preferably a color layer with bright color particles of color pigments or dyes. The second personalization layer may, however, also contain black particles. It is preferably provided that the second personalization layer consists only of bright color particles. “Only of bright color particles” means in particular that the second personalization layer does not contain any black particles.

Within the scope of the aforementioned important concept, a laser additive may be integrated or dispersed in the color particles. This is advantageous since in this way a tamper protection means, which protects the identification document against the subsequent addition of black portions by means of laser engraving in the first personalization layer, can be integrated in the identification document at the same time as the second personalization layer is being applied. Such a tampering attempt has the result that laser engraving takes place at the same time on the second personalization layer. This laser engraving of the second personalization layer can be identified by the naked human eye or even haptically felt on the surface.

Within the scope of the aforementioned important concept, a protective layer in which a laser additive is likewise integrated may alternatively or additionally be arranged above the second personalization layer. As a result, it is alternatively possible to use the protective layer to obtain the same or even an additional tamper protection means, as explained above in connection with the second personalization layer.

The protective layer may be applied to the full area over the entire surface of the carrier element; this is advantageous since the protective layer can be added to the carrier element in one step as a closed surface. The protective layer may be applied to the surface partially, but at least over the entire surface area of the personalization region, i.e. the second personalization layer; this is advantageous if the protective layer is to be applied at the same time as or immediately after the second personalization layer is created line-by-line, if appropriate also line-by-line or in portions, using the same device used to create the second personalization layer. In this case, it is also possible to partially add the laser additive to the protective layer when the protective layer is being applied or to correspondingly switch between a material for the protective layer having a laser additive and not having a laser additive. It is also likewise possible to partially apply the protective layer above the second personalization layer, wherein the partial application can be used to form a symbol, a text or a routine structure; this is advantageous because in this way optical changes owing to tampering with a laser that can be identified more easily by the naked eye can be generated. It is particularly advantageous that a desired structure, which is to be identifiable owing to the resulting blackening caused by a subsequent tampering attempt using a laser, can be preset by partial deposition of the protective layer with an integrated laser additive or virtually by partial integration of the laser additive in the protective layer.

The second personalization layer and, if appropriate, the protective layer are preferably printed layers. For example, the second personalization layer and/or, if appropriate, the protective layer can be effected by digital printing, wherein dye transfer to the surface of the carrier element takes place by means of D2T2 printing, thermal transfer printing, inkjet printing or liquid ink printing and/or retransfer printing. The protective layer may alternatively be arranged above the second personalization layer in the form of a film or a coat of lacquer.

In a particular refinement of the identification document, the sensitization to laser beams in the carrier element is set to be weaker in the region of the first personalization layer than, if appropriate, in the second personalization layer and/or, if appropriate, the protective layer. This has the advantage that it additionally makes subsequent laser engraving of the first personalization layer more difficult in that the second personalization layer and/or, if appropriate, the protective layer respond to the input of energy by laser beams earlier than the first personalization layer does, as a result of which the tamperproofing with respect to subsequent laser engraving can be increased further.

The identification document may be in the form of a card or a data carrier. The identification document may be in the form of a passport, a personal ID card, a driver's license, a bank card, for example a credit card or cash card, a label and/or an access card. The identification document may also form only part of a larger unit, for example part of a passport.

It should be noted that the identification document may also have multiple surfaces, for example a front side and a back side. In this case, it is possible for one surface to have one or more personalization regions according to the principles explained above. The personalization regions in a surface may, for example, directly adjoin one another or be formed at a spacing from one another. The personalization region is preferably restricted to a subregion of one of the surfaces, in particular the subregion in which the first personalization layer is located. In principle, however, the first personalization region may also extend over the entire surface.

The surface of the carrier element in the personalization region may have a structuring. To this end, the surface of the carrier element in the personalization region may be formed with a multiplicity of structural elements which are aligned uniformly in relation to one another and are raised with respect to the surface. The structural elements of the multiplicity of structural elements may be formed directly adjoining one another. The structural elements may have an axial distance between vertical axes, which are normals to the surface, of the respective structural elements of less than 250 μm. At least one structural element of the multiplicity of structural elements may at least partially have an arcuate outline in cross section perpendicularly in relation to the surface; the arcuate outline may be formed with a radius of at most 125 μm. At least one structural element of the multiplicity of structural elements may be dome-shaped on the side facing away from the carrier element. At least one structural element of the multiplicity of structural elements may be in the form of a circular segment, wherein the sectional area of the circular segment faces toward the carrier element. At least one structural element of the multiplicity of structural elements may be in the form of a semicircular bar. The structural elements of the multiplicity of structural elements may each have a height of 10 μm to 60 μm. The structural elements of the multiplicity of structural elements may be aligned in relation to one another in the form of a uniform pattern.

If the surface of the carrier element in the personalization region comprises the multiplicity of structural elements aligned in relation to one another in the form of a uniform pattern, the second personalization layer in the personalization region with the multiplicity of structural elements may be at least partially in the form of a tilting image. Here, it is advantageous for the neutral portion, or black portion, of the tilting image to be integrated in the carrier element by means of the first personalization layer. For example, the tilting image may be in the form of an MLI (multiple laser image) or CLI (changeable laser image).

According to a second aspect of the invention, a system arrangement for personalizing a non-personalized identification document comprises: a first device for providing a carrier element with a surface which has a personalization region; a second device, in particular a laser writer, for creating a first personalization layer in the carrier element in the personalization region at a depth below the surface by means of laser engraving; a third device, in particular a printing device, for creating a second personalization layer on and/or in the surface of the carrier element in the personalization region. According to the important concept, in the case of the system arrangement it is provided that the device for creating the second personalization layer is configured to integrate a laser-sensitive additive (laser additive) in the second personalization layer, and/or is configured to apply a protective layer, containing the laser additive, above the second personalization layer after or in parallel with creating the second personalization layer.

A third aspect of the invention proposes a method for personalizing a non-personalized identification document with an analogous design to the system arrangement. The method comprises the following steps: a step A of providing a carrier element with a surface which has a personalization region; a step B of creating a first personalization layer in the carrier element in the personalization region at a depth below the surface by means of laser engraving; a step C of creating a second personalization layer on and/or in the surface of the carrier element in the personalization region. According to the important concept, in the method it is provided that the step C additionally comprises a step CI of integrating a laser-sensitive additive (laser additive) in the second personalization layer, and/or a step C2 of arranging a protective layer, containing the laser additive, above the second personalization layer.

It should be noted that the identification document is personalized by way of the system arrangement or the method. The embodiments presented in relation to the identification document and their advantages apply correspondingly to the system arrangement and to the method and vice versa, and therefore here reference is made interchangeably to avoid repetitions.

In terms of the materials for the constituents of the identification document, it should also be noted: The carrier element is preferably made of a plastic. In particular, the carrier element may be single-layered or multilayered, for example made of PVC (polyvinyl chloride) and/or PET (polyethylene terephthalate) and/or ABS (acrylonitrile-butadiene-styrene) and/or polycarbonate. The structural elements, if present, are preferably made of polycarbonate. This is advantageous since polycarbonate makes it possible to give the structural elements a particularly hard form which is resistant to mechanical action. When the carrier element is being produced, the multiplicity of structural elements may already be formed on the carrier element, for example by injection molding or by high-pressure welding at a corresponding temperature to form a homogeneous, inseparable plastics unit, i.e. in particular by hot pressing or laminating.

As a result, the identification document can be more effectively secured against forgery by providing the protection against subsequent laser engraving proposed here, for example for a face morphing attack. A known identification document could possibly be subsequently forged by manipulating the first personalization layer of an identification document already personalized with image information by adding additional black portions to the first personalization layer using laser engraving for a face morphing attack. In the exemplary embodiments of the identification document proposed here with a laser additive in the second personalization layer and/or a protective layer arranged on the second personalization layer, subsequent laser engraving of the first personalization layer has the result that the second personalization layer and/or the protective layer arranged on the second personalization layer is also engraved in a way that can be optically identified by the naked human eye and/or felt or touched on the surface of the personalization region owing to the input of energy by means of a laser. Such subsequent forging can then be identified more easily than if a known identification document is subsequently engraved only in the first personalization layer by means of a laser.

Further features of the invention will emerge from the claims, the figures and the description of the figures.

Exemplary embodiments of the invention will be explained in more detail below with reference to schematic drawings, in which:

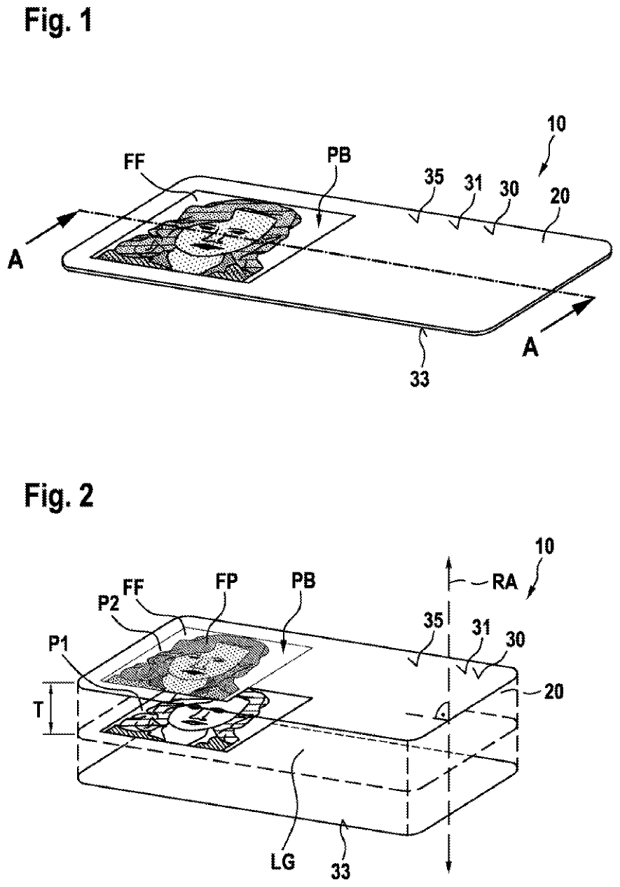

FIG. 1 shows a perspective depiction of an exemplary embodiment of an identification document according to the invention;

FIG. 2 shows a perspective depiction, pulled apart in the direction of a spatial axis, of the identification document of FIG. 1 to illustrate the first personalization layer and the second personalization layer in the personalization region;

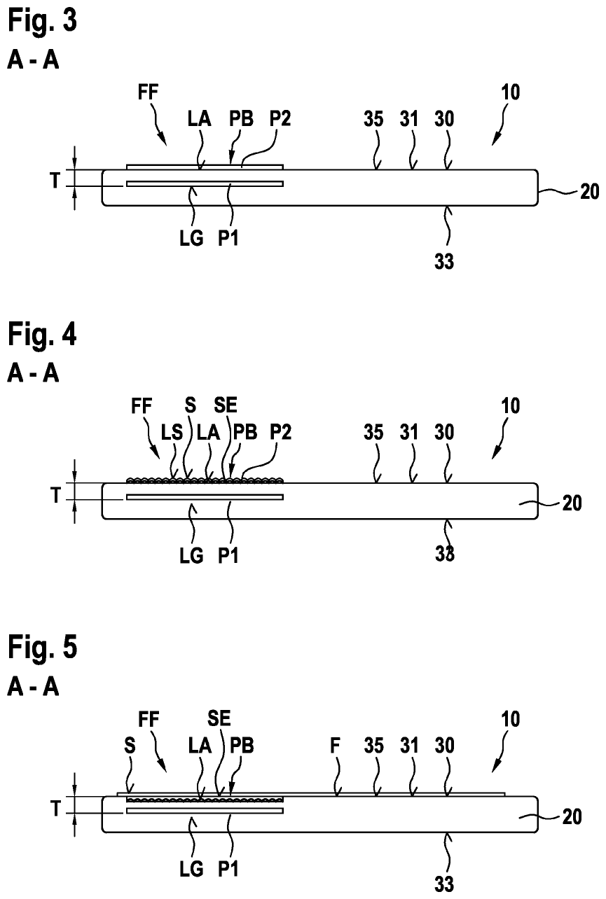

FIG. 3 shows a cross-sectional side view of the identification document of FIG. 1 looking toward the sectional area A-A of FIG. 1 according to a first exemplary embodiment;

FIG. 4 shows a cross-sectional side view of the identification document of FIG. 1 looking toward the sectional area A-A of FIG. 1 according to a second exemplary embodiment

FIG. 5 shows a cross-sectional side view of the identification document of FIG. 1 looking toward the sectional area A-A of FIG. 1 according to a third exemplary embodiment;

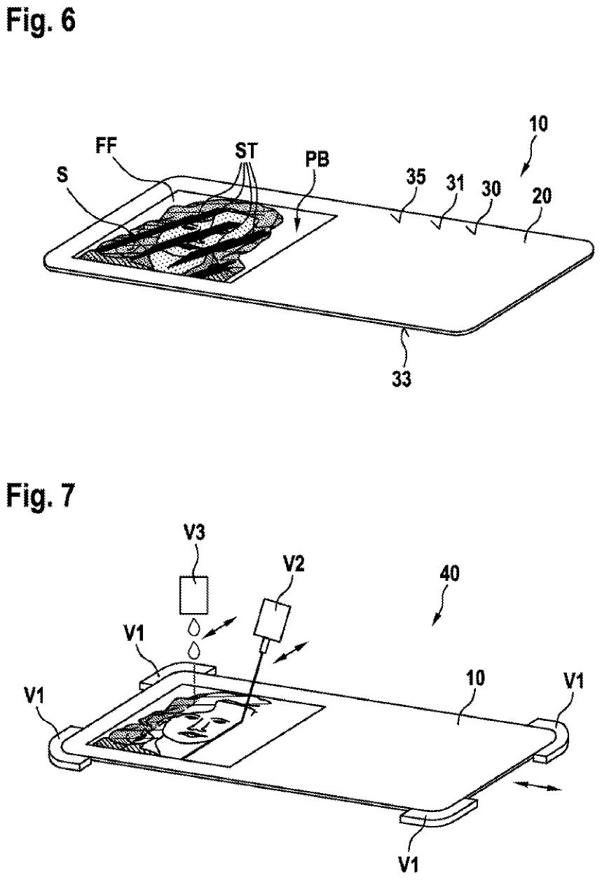

FIG. 6 shows a perspective depiction of an exemplary embodiment of an identification document according to the invention having an optically visible structure as a consequence of a manipulation attempt by means of subsequent laser engraving;

FIG. 7 shows a simplified schematic depiction of a system arrangement for personalizing an information document according to the invention and for protecting it against subsequent laser engraving; and

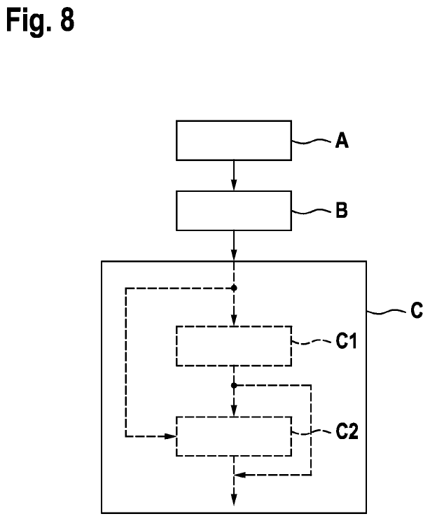

FIG. 8 shows a schematic flow diagram to illustrate one of the steps of a method for personalizing an information document according to the invention and for protecting it against subsequent laser engraving.

Elements that are the same or have the same function are provided with the same reference signs in the figures.

FIG. 1 shows a perspective depiction of an exemplary embodiment of an identification document 10 according to the invention. FIG. 1 indicates a sectional line A-A which defines the sectional side depiction for illustrating various embodiments of the identification document 10 in FIGS. 3 to 5.

According to the exemplary embodiment illustrated, the identification document 10 is in the form of a card, for example a personal ID card or a driver's license or a bank card or an access card, to non-exhaustively name a few specific possible uses.

The identification document 10 comprises a carrier element 20. The carrier element 20 is made of plastic, for example. The carrier element 20 may have a single-layered or multilayered form. The materials may expediently be different, similar or identical.

The carrier element 20 has a surface 30, which is the front side 31 of the card according to the exemplary embodiment. The carrier element may also have multiple surfaces, for example a front side 31 and a back side 33. The surface 30 has a main plane 35 and a personalization region PB. According to the exemplary embodiment, the main plane 35 is defined by the surface 30, which is located outside the personalization region PB. The personalization region PB extends in particular only partially over the surface 30. As an alternative, the personalization region PB may, however, also extend completely over the entire surface 30. In the case of a personalized identification document 10, the personalization region PB of the exemplary embodiments explained here presents a color photo FF of the face of the holder of the identification document.

FIG. 2 shows a perspective depiction of the identification document 10 of FIG. 1 pulled apart in the direction of a spatial axis RA to illustrate the personalization region PB, which has a first personalization layer P1 and a second personalization layer P2.

In the exemplary embodiments depicted here, the personalization region PB of a personalized identification document 10 presents a color photo FF, which shows a human face of a holder of the identification document 10; the personalization links the document identity to biometric features of the holder, with the result that the holder can be identified by a match with the color photo FF in the personalization region PB for a positive match.

The first personalization layer P1 preferably contains the neutral portion, i.e. the black portion, of the color photo FF and the second personalization layer P2 contains the colored portions or color separations of the color photo FF. The black portion may, however, also be present in the second personalization layer P2. The black portion is preferably introduced into the material of the carrier element 20 of the identification document 10 by means of integrated laser engraving LG (referred to among other things as LIP—laser image protection) and the colored portions are applied for example by means of inkjet printing technology or by laminating a transfer film onto the surface 30 of the identification document 10 in the personalization region PB. The second personalization layer P2 is preferably applied only with bright color particles FP. In this way, the neutral black portion that remains in comparison with the bright color particles FP is not applied to the surface 30, but rather is integrated or embedded in the carrier element 20 by means of LIP.

The first personalization layer P1 created in the carrier element 30 by means of LIP is located at a depth T in relation to the surface 30, in particular the front side 31, of the carrier element 20 and is thus at a spacing from the second personalization layer P2 and from the surface 30. The material of the carrier element is preferably transparent, at least to visible light, in the region between the first and the second personalization layer P1 and P2.

The combination of two different methods for creating a common optical indicator in the personalization region PB in the form of a color photo FF that has optical biometric features of the holder and thus virtually forms a corresponding security feature makes it particularly difficult to reproduce the identification document 10. This combination of a black portion and a color portion is known as CLIP ID (color laser image protection ID).

FIGS. 3 to 5 each non-exhaustively show various exemplary embodiments for the structural design of the identity document 10 according to the invention with reference to the cross-sectional view A-A, defined in FIG. 1, of the identity document 10. In all three exemplary embodiments of FIGS. 3 to 5, the first personalization layer P1 is at a depth T with respect to the surface 30 of the carrier element 20. The

In the exemplary embodiment depicted in FIG. 3, a laser-sensitive additive (laser additive) LA is integrated or dispersed in the color particles used to form the second personalization layer P2. This feature makes the second personalization layer P2, which was created by means of a printing technology, in particular an inkjet printing technology, such as liquid ink printing with drop-on-demand (DoD), sensitive to the input of energy by means of a laser. The laser additive LA may for example contain carbon black particles or metal oxide nanoparticles, which, if the particle density is expediently set, do not adversely affect the optical properties of the second personalization layer P2 for visible light but absorb enough energy when irradiated with a laser that a corresponding carbonization of the second personalization layer and, if appropriate, in the surface 30 of the adjoining carrier element 20 takes place. As a result, it is possible to have the effect that an attempt to subsequently add black portions to the first personalization layer P1 with a laser by means of laser engraving LG causes a corresponding laser engraving LG in the second personalization layer P2. In this way, such a manipulation attempt, for example for a face morphing attack, is made considerably more difficult, if not completely thwarted.

In FIGS. 4 and 5, in comparison with the exemplary embodiment of FIG. 3, the carrier element 20 is formed with a multiplicity of structural elements SE in the personalization region PB. The structural elements SE of the multiplicity of structural elements SE, here referred to in brief as structural elements SE, are raised in relation to the main plane 35 in FIG. 4, whereas they substantially terminate facing the main plane 35 in FIG. 5. That is, in the exemplary embodiment of FIG. 4 the structural elements SE are located on the main plane 35 of the carrier element 20, whereas in the exemplary embodiment of FIG. 5 the structural elements SE are arranged on a plane which is inside the carrier element 20 with respect to the main plane 35 of the carrier element 20, with the result that the structural elements SE are not raised with respect to the carrier element 20.

In the exemplary embodiments of FIGS. 4 and 5, the structural elements SE are in particular formed such that they point away from the carrier element 20, preferably in the direction of the spatial axis RA (FIG. 2). The structural elements SE according to the exemplary embodiments of FIGS. 4 and 5 are arranged uniformly and at least partially have an arcuate outline in cross section perpendicularly in relation to the main plane 35.

One advantage of the identification document 10 of FIGS. 4 and 5 is that the structural elements SE make it possible to use on the one hand standard inkjet inks that bond less well to the surface 30 but also polycore inks that bond very well to the substrate for the second personalization layer P2, and at the same time to obtain high stability of the second personalization layer P2 with respect to mechanical and/or chemical influences. The identification document 10 and the method for personalizing the identification document 10 with structural elements SE in the personalization region PB make it possible to increase the durability in the long term of the external second personalization layer P2.

In particular, the personalization region PB in FIGS. 4 and 5 is characterized in that the second personalization layer P2 is introduced onto or into the surface 30 of the carrier element 20 in the long term, that is preferably at least for a duration of several months, in particular at least one year or even up to ten years.

In the exemplary embodiment of FIG. 4, firstly the second personalization layer P2 is applied to the structural elements SE. A protective layer S in the form of a coat of lacquer LS, which is doped with a laser additive LA or in the material of which the laser additive LA is dispersed, is also applied to the second personalization layer P2. As a result, it is therefore possible to obtain the same protection against subsequent laser engraving of the first personalization layer P1 as in the exemplary embodiment of FIG. 3.

That is, in comparison to the exemplary embodiment of FIG. 3, the second personalization layer P2 in the exemplary embodiment of FIG. 4 does not contain a laser additive LA, but rather only the additional protective layer S. However, it goes without saying that it is fundamentally possible to integrate the laser additive LA both in the second personalization layer P2 and in the protective layer S. This further exemplary embodiment is not depicted in the figures.

In the exemplary embodiment of FIG. 5, firstly the second personalization layer P2 is applied to or pressed in onto the structural elements SE that are recessed in the surface 30 of the carrier element 20. A protective layer S in the form of a film F, which is doped with a laser additive LA or in the material of which the laser additive LA is dispersed, is then also applied above the second personalization layer P2. As a result, it is therefore possible to obtain the same protection against subsequent laser engraving of the first personalization layer P1 as in the exemplary embodiments explained in connection with FIGS. 3 and 4. The protective layer S in the form of a film F is applied to the full area over the entire surface 30 of the carrier element 20 in the exemplary embodiment of FIG. 5. This is advantageous if a uniform closed surface is desired for the identity document 10.

It should be noted that it is also possible to provide a full-area protective layer S or a protective layer partially restricted to the personalization region PB, and it is possible for the protective layer in turn to contain or not contain a laser additive LA, in the exemplary embodiments depicted in FIGS. 3 and 4.

With regard to all embodiments with a protective layer S, it should be noted that the protective layer S in principle can be applied as a film F (FIG. 5) or in the form of a coat of lacquer LS (FIG. 3) by means of a printing technology suitable for this, for example using an inkjet printing technique or liquid ink printing by means of drop-on-demand (DoD). A less preferred combination of a protective layer S in the form of a film F and a coat of lacquer LS is also conceivable.

According to an advantageous refinement of the exemplary embodiments with a protective layer S that were explained above, the following should be added. The protective layer S in the form of a film For a coat of lacquer LS can subsequently be applied to the second personalization layer P2 with the personalized pictorial data partially or over the entire surface area at least in the personalization region PB. The partial application may be structured, for example in the form of an image, a logo, a text or a uniform pattern, it being preferable for the laser additive LA to be integrated homogeneously in the protective layer S. The provision of a structured protective layer S is advantageous because in this way subsequent laser engraving of the first personalization layer P1 has the result that the structuring of the protective layer S is only then optically clearly visible and thus the manipulation can already be identified more easily by the naked human eye. This is illustrated by way of example in FIG. 6.

FIG. 6 shows a perspective depiction of an exemplary embodiment of an identification document 10 according to the invention having an optically visible structure ST as a consequence of a manipulation attempt by means of subsequent laser engraving of the first personalization layer P1. It is not in any way limiting that in the exemplary embodiment of FIG. 6 the protective layer S provided with the integrated laser additive has been applied in the form of uniform transverse strips in the personalization region PB of the identity document 10, for example by an inkjet printing technique. The protective layer S structured in this way has blackened owing to a subsequent attempt to laser engrave the first personalization layer P1 and is identifiable as the optically identifiable structure ST. The color photo FF in the personalization region PB thus shows the manipulation attempt clearly by means of the optically identifiable structure ST in the form of the transverse strips shown by way of example.

It should be noted that, in an embodiment without a protective layer S, it is likewise possible for the laser additive LA to be added selectively as the color particles are being applied for the second personalization layer P2, with the result that it is also possible to obtain a structuring of the sensitization to laser beams in the second personalization layer P2.

Lastly, it should also be noted that the sensitization to laser beams in the material can be set as weaker in the region of the first personalization layer P1 than in the second personalization layer P2 and/or, if appropriate, the protective layer S. This has the advantage that it additionally makes subsequent laser engraving of the first personalization layer P1 more difficult, in that the second personalization layer P2 and/or, if appropriate, the protective layer S respond to the input of energy by laser beams earlier than the first personalization layer P1 does, as a result of which the tamperproofing with respect to subsequent laser engraving can be increased further.

FIG. 7 shows a simplified schematic depiction of a system arrangement for personalizing an information document according to the invention and for protecting it against subsequent laser engraving. In principle, the system arrangement 40 for personalizing an identification document 10 is provided with the system components that are known, for example, in connection with the CLIP ID technology mentioned elsewhere.

Firstly, the system arrangement 40 has a first device V1, which is intended for providing a non-personalized identification document 10 with the carrier element 20 having the surface 30, which has the personalization region PB for a personalization. To personalize the identification document 10, the system arrangement 40 has a second device V2, for example a laser writer. The second device V2 is configured to create the first personalization layer P1 in the carrier element 20 in the personalization region PB at a depth T below the surface 30 by means of laser engraving LG. Likewise for personalization of the identification document 10, the system arrangement 40 has a third device V3, for example an inkjet printing device with DoD liquid ink printing, for creating the second personalization layer P2 on and/or in the surface 30 of the carrier element 20 in the personalization region PB.

To improve the tamperproofing of the identification document 10, the third device V3 is additionally configured to create the second personalization layer P2, to integrate a laser additive LA in the second personalization layer P2, and/or to apply a protective layer S, containing the laser additive, above the second personalization layer P2 after or in parallel with creating the second personalization layer P2. It goes without saying that, correspondingly to the exemplary embodiment explained above, the system arrangement 40 may be configured to structure the presence of laser additive in the second personalization layer P2 and/or the protective layer S.

In connection with the system arrangement 40, it should also be noted that the first personalization layer P1, the second personalization layer P2 and, if appropriate, the protective layer S may in principle be created one after another. However, it is also possible to be able to create the first personalization layer P1 and the second personalization layer P2 in parallel, but in portions or line-by-line with a temporal offset; this means the second device V2 firstly engraves one of the multiple lines of the first personalization layer P1 and then (i.e. with a temporal offset) the third device V3 applies the corresponding lines of the second personalization layer P2 above the already created lines of the first personalization layer P1, while the second device V2 already creates a further line or lines of the first personalization layer P1. The protective layer, if present, can be correspondingly applied in a temporal relationship with the second personalization layer P2.

FIG. 8 shows a schematic flow diagram to illustrate the steps of a method for personalizing an information document 10 according to the invention and for protecting it against subsequent laser engraving.

The method for personalizing an identification document 10 comprises the following steps: a step A of providing a not yet personalized identification document 10 with a carrier element 20 having a surface 30 which has a personalization region PB; a step B of creating a first personalization layer P1 in the carrier element 20 in the personalization region PB at a depth T below the surface 30 by means of laser engraving; a step C of creating a second personalization layer P2 on and/or in the surface 30 of the carrier element 20 in the personalization region PB.

To improve the tamperproofing of the identification document 10, it is provided that, in step C, the method also comprises: a step C1 of integrating a laser additive in the second personalization layer P2 and/or a step C2 of arranging a protective layer S, containing the laser additive, above the second personalization layer P2.

1.-15. (canceled)

16. An identification document comprising a carrier element, which has a surface with a personalization region,
wherein a first personalization layer is integrated in the carrier element in the personalization region at a depth below the surface; and a second personalization layer is located on and/or in the surface in the personalization region;
wherein a laser additive is integrated in the second personalization layer and/or in a protective layer arranged above the second personalization layer.

17. The identification document according to claim 16, wherein the first personalization layer is defined by a laser engraving, which is embedded or integrated in the carrier element and is formed by at least partial carbonization of the material of the carrier element.

18. The identification document according to claim 17, wherein a laser additive is likewise present in the carrier element in the region of the first personalization layer.

19. The identification document according to claim 16, wherein the second personalization layer is a color layer with bright color particles.

20. The identification document according to claim 19, wherein the laser additive is integrated or dispersed in the color particles.

21. The identification document according to claim 16, wherein the protective layer is arranged above the second personalization layer in certain regions or over the entire surface area, and the laser additive is integrated in the protective layer partially or over the entire surface area.

22. The identification document according to claim 16, wherein the second personalization layer and, if appropriate, the protective layer are printed.

23. The identification document according to claim 22, wherein the second personalization layer and, if appropriate, the protective layer are obtained by printing by means of D2T2 printing, thermal transfer printing, inkjet printing and/or retransfer printing.

24. The identification document according to claim 16, wherein the protective layer is arranged above the second personalization layer in the form of a film or a coat of lacquer.

25. The identification document according to claim 16, wherein the laser additive contains particles designed to absorb energy from a laser, in particular carbon black particles and/or metal oxide nanoparticles.

26. The identification document according to claim 16, wherein a sensitization to laser beams in the carrier element is set to be weaker in the region of the first personalization layer than, if appropriate, in the second personalization layer and/or, if appropriate, the protective layer.

27. The identification document according to claim 16, wherein the first personalization layer contains a black portion and the second personalization layer contains a colored portion of a color image, in particular a color image of the face of the holder of the identification document, and are aligned overlapping one another in register in the direction of a normal to the surface of the carrier element.

28. The identification document according to claim 16, wherein the identification document is in the form of a card or a data carrier, in particular a passport, a personal ID card, a driver's license, a bank card, for example a credit card or cash card, a label and/or an access card.

29. A system arrangement for personalizing an identification document, comprising:
a) a first device for providing a carrier element with a surface which has a personalization region;
b) a second device, in particular a laser writer, for creating a first personalization layer in the carrier element in the personalization region at a depth below the surface by means of laser engraving;
c) a third device, in particular a printing device, for creating a second personalization layer on and/or in the surface of the carrier element in the personalization region);
wherein the third device for creating the second personalization layer is configured to integrate a laser additive in the second personalization layer; and/or is configured to apply a protective layer, containing the laser additive, above the second personalization layer.

30. A method for personalizing an identification document, comprising the following steps:
a step A of providing a carrier element with a surface which has a personalization region;
a step B of creating a first personalization layer in the carrier element in the personalization region at a depth below the surface by means of laser engraving;
a step C of creating a second personalization layer on and/or in the surface of the carrier element in the personalization region;
wherein the method, in step C, comprises a step C1 of integrating a laser additive in the second personalization layer; and/or comprises a step C2 with a step C2 of arranging a protective layer, containing the laser additive, above the second personalization layer.
